(19) United States
(12) Patent Application Publication
(10) Pub. No.: US 2012/0162689 A1
(43) Pub. Date: Jun. 28, 2012

(54) PRINT CONTROL DEVICE, PRINT CONTROL METHOD, AND STORAGE MEDIUM

(75) Inventor: Kimio Hayashi, Tokyo (JP)

(73) Assignee: CANON KABUSHIKI KAISHA, Tokyo (JP)

(21) Appl. No.: 13/328,430

(22) Filed: Dec. 16, 2011

(30) Foreign Application Priority Data
Dec. 24, 2010 (JP) 2010-286987

(51) Int. Cl. G06K 15/16; G06F 3/12

(52) U.S. Cl. 358/1.14; 358/1.15

(57) ABSTRACT

A customer PC receives running status information regarding the running status of print processing from a print device, refers to setting information regarding the division of the print job, and determines whether or not a setting for the division of the print job is made based on running status information. When a setting for the division of the print job is made based on running status information, the customer PC collects the records of variable data based on running status information, and divides the print job for each division unit corresponding to the number of records of the collected variable data. Then, the customer PC transmits the divided print job to a print device.

### BACKGROUND OF THE INVENTION

1. Field of the Invention

The present invention relates to a print control device, a print control method, and a storage medium.

2. Description of the Related Art

An image forming device that executes variable data printing (VDP) for printing data in accordance with the individual customer's needs has been proposed. The image forming device for executing VDP performs printout, for example, by replacing the content of each document one by one. For example, the image forming device receives a variable data print job (VDP job) from a print control device, and performs print processing for a record corresponding to the VDP job.

A VDP job is a print job for performing VDP. The VDP job includes reusable data (common data that is referenceable in a plurality of times) that is repeatedly employed on each page, and a large number of variable data (data that is not referenceable a plurality of times) including customer information or the like. Since reusable data is common data, reusable data needs to be transferred to and processed by the image forming device prior to variable data. Also, a record is a processing unit for a series of VDP. For example, when the image forming device performs printout on a per-customer basis, print data for one customer is one record.

On the other hand, currently, the standardization bodies such as CIP4, PODi, ISO, and the like have investigated “print workflow-enabled” and “increase in efficiency for print processing” using JDF and JMF. JDF is an abbreviation for Job Definition Format and JDF is an instruction for a print step. Also, JMF is an abbreviation for Job Messaging Format and JMF is an operation report.

An explanation will be given on an investigation focused on “print workflow-enabled”. In a printing system using JDF, the JMF Signal specification in which the running status of a job is transmitted to the specified address upon the occurrence of an event in an image forming device is provided as a unit configured to report the printing status of the job. The printing system uses a JMF Signal when an operation status report or the result of some event (e.g., paper jam, print completion, or the like) is transmitted from an image forming device to a VDP application provided in a print control device. A VDP application is an application for generating a VDP job.

An explanation will be given on the study focused on an “increase in efficiency for print processing”. One VDP job may include a plurality of records. Thus, it is contemplated that a print control device divides an overall VDP job into a plurality of VDP jobs in units of a predetermined number of records, and transmits the divided VDP jobs to the image forming device for sequential printout. For example, in a direct mail for a credit card, one VDP job may include several thousands of records to several tens of thousands of records.

As a VDP job division technology, a system in which a VDP job is divided by a VDP application has been proposed based on the assumption that an image forming device continues to execute an efficient operation. For example, Japanese Patent Laid-Open No. 2004-348194 discloses an electronic document printing system in which an electronic document is divided into three or more data blocks, and the rear-most data block is firstly transferred to a print device and the remaining data blocks are then transferred to the print device in the order from the leading data block. Also, Japanese Patent Laid-Open No. 2004-348622 discloses an electronic document printing system in which electronic documents are edited into new electronic document data blocks for each page, and forms imaging of the data blocks into one file for transfer to thereby transmit the file to a print device. For example, according to a Print Shop Mail by ObjectfLune corporation, an electronic document division instruction may be made for each page on a user interface.

In the aforementioned technology in which a VDP job is divided by a VDP application based on the assumption that an image forming device continues to perform an efficient operation, a VDP job is not divided in response to the running status of print processing performed by an image forming device. Therefore, a situation to be described below in conjunction with (1) and (2) may occur, resulting in an undesired extension of a print time corresponding to an overall VDP job.

(1) Since an image forming device for handling a VDP job typically has a high processing speed, the number of jobs waiting to be printed in a job reception queue provided in the image forming device quickly decreases. A job reception queue is a queue that stores a VDP job(s) which has been received from a print control device by the image forming device. A job waiting to be printed is a VDP job in a state of waiting to be printed. If a VDP application provided in the print control device continues to execute the time-consuming data transfer task without taking the number of jobs waiting to be printed in a job reception queue provided in the image forming device into consideration, the job waiting to be printed in a job reception queue may be lost. When the number of jobs waiting to be printed in a job reception queue provided in the image forming device is small and continuous printing is about to be interrupted, the print control device should execute a record which does not take time to transfer.

(2) If the VDP application transfers print data, which does not take time to transfer, to the image forming device while the print engine of the image forming device is stopped due to the occurrence of paper jam or the like, the following situation may occur. Specifically, the VDP application centrally performs transfer processing for the time-consuming print data afterwards, and thus, the job waiting to be printed in a job reception queue provided in the image forming device is lost. Consequently, continuous printing may undesirably be interrupted. When the print engine of the image forming device is stopped, the print control device should transmit print data, which takes time to transfer, as much as possible.

In other words, since the conventional print control device does not divide a VDP job to be processed for each division unit corresponding to the running status of print processing such as the number of jobs waiting to be printed, the state of the print engine, or the like, the conventional print control device cannot perform processing for a VDP job in an efficient way.

### SUMMARY OF THE INVENTION

The print control device of the present invention divides a VDP job to be processed for each division unit corresponding to the running status of print processing performed by an image forming device and transmits the divided VDP jobs to the image forming device.

According to an aspect of the present invention, a print control device is provided that divides a print job, transmits the divided print job to an image forming device, and causes the image forming device to execute print processing for print data corresponding to the print job. The print data is first data that is shared among a plurality of pages or second data that is variable for each page. Also, the print control device includes a reception unit configured to receive running status information regarding the running status of the print processing from the image forming device; a setting determination unit configured to refer to setting information regarding the division of the print job and to determine whether or not a setting for the division of the print job is made based on the running status information; a collection unit configured to collect a record of second data based on the running status information when the setting determination unit has determined that a setting for the division of the print job is made based on the running status information; a division unit configured to divide the print job for each division unit corresponding to the number of records of the collected second data; and a transmission unit configured to transmit the divided print job to the image forming device.

Further features of the present invention will become apparent from the following description of exemplary embodiments with reference to the attached drawings.

### BRIEF DESCRIPTION OF THE DRAWINGS

FIG. 1 is a diagram illustrating an example of the configuration of the printing system of the present embodiment.

FIG. 2 is a functional block diagram illustrating an example of a customer PC.

FIG. 3 is a diagram illustrating an example of a setting file of a VDP application.

FIG. 4 is a diagram illustrating an example of an UI screen displayed by a VDP application.

FIG. 5A is a diagram illustrating an example of record database.

FIG. 5B is a diagram illustrating an example of print data included in a print job.

FIG. 6 is a diagram illustrating an example of a JMF Signal according to a first embodiment.

FIG. 7 is a diagram illustrating an example of the flow of division processing for a VDP job according to the first embodiment.

FIG. 8 is a flowchart illustrating an example of record collection processing.

FIG. 9 is a diagram illustrating an example of a JMF Signal according to a second embodiment.

FIG. 10 is a flowchart illustrating an example of record collection processing.

### DESCRIPTION OF THE EMBODIMENTS

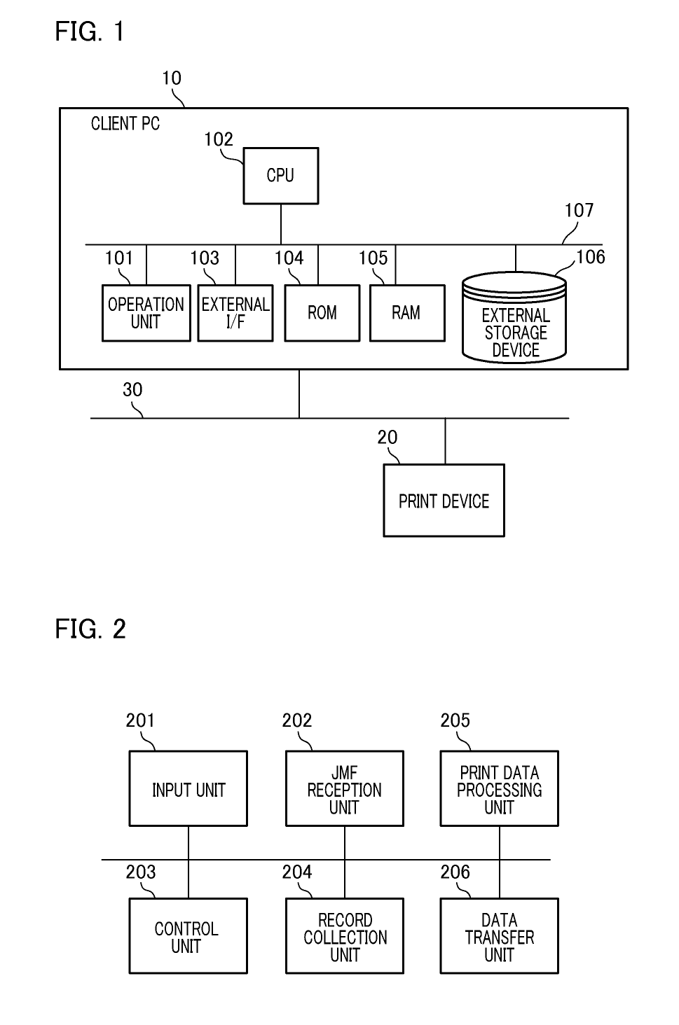

FIG. 1 is a diagram illustrating an example of the configuration of a printing system of the present embodiment. The printing system shown in FIG. 1 includes a customer PC (Personal Computer) 10 and a print device 20. The customer PC 10 is connected to the print device 20 so as to enable communication between them via a network 30 such as LAN (Local Area Network), WAN (Wide Area Network), or the like.

The customer PC 10 is the print control device of the present embodiment. The customer PC 10 divides a print job, transmits the divided print job to the print device 20, and causes the print device 20 to execute print processing for print data corresponding to the print job.

In the present embodiment, a print job to be divided is a VDP job. Print data corresponding to the VDP job is reusable data (first data) that is shared among a plurality of pages and variable data (second data) that is variable for each page. In the present embodiment, the division of a print job (VDP job) is to collect records matching a predetermined condition from the records of print data included in the print job to thereby generate a new print job corresponding to the collected records.

A VDP application is pre-installed in the customer PC 10. The VDP application has a function that generates, edits, provides a print instruction, and transmits a VDP job. An operator, that is, a user of the customer PC 10, can confirm the state of a VDP job using the VDP application. The print device 20 is an image forming device and has various functions such as scanning, printing, copying, or the like.

The customer PC 10 includes an operation unit 101, a CPU (Central Processing Unit) 102, and an external I/F (Interface) 103. The customer PC 10 further includes ROM (Read Only Memory) 104, RAM (Random Access Memory) 105, and an external storage device 106. The operation unit 101 to the external storage device 106 are connected to each other via a system bus 107.

The operation unit 101 inputs input information in response to a user's operation. The CPU 102 controls the customer PC 10 overall. The external I/F 103 mediates communication between the customer PC 10 and the print device 20 via the network 30. More specifically, the external I/F 103 mediates transmission of a VDP job from the customer PC 10 to the print device 20. Also, the external I/F 103 mediates transmission/reception of a JMF Signal that is executed between the customer PC 10 and the print device 20.

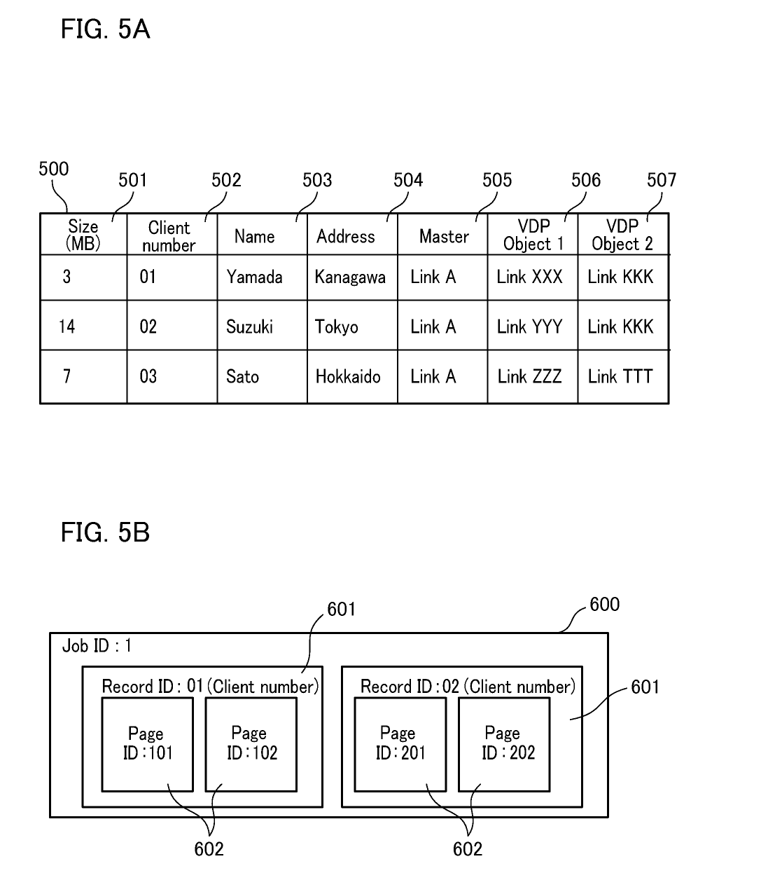

The ROM 104 is a read only memory. The ROM 104 includes a storage region for a system control program, font data, or the like. The RAM 105 is a memory that is loaded with a computer program and data that correspond to the process executed by the customer PC 10. A program loaded onto the RAM 105 is executed by the CPU 102. The external storage device 106 is, for example, a hard disk device or the like. The external storage device 106 stores a program to be executed by a CPU in advance. Upon execution of the process, the CPU 102 refers to a program stored in the external storage device 106 or loads the program onto the RAM 105. Also, the external storage device 106 stores a record database 500, to be described below, with reference to FIG. 5A.

FIG. 2 is a functional block diagram illustrating an example of the customer PC shown in FIG. 1. More specifically, FIG. 2 shows an exemplary configuration of the VDP application installed on the customer PC 10. The VDP application includes an input unit 201, a JMF reception unit 202, a control unit 203, a record collection unit 204, a print data processing unit 205, and a data transfer unit 206. The processing units included in the VDP application are realized by a computer program executed by the CPU 102.

The input unit 201 displays a UI (User Interface) screen. For example, the input unit 201 displays a dialogue 400 shown in FIG. 4 to be described below. When a user performs various setting operations on the dialogue 400, the input unit 201 receives input information corresponding to the setting operation. Input information includes setting information about the division of a print job.

The JMF reception unit 202 functions as a reception unit that receives a JMF Signal from the print device 20 via the network 30 and the external I/F 103. The JMF Signal includes information (running status information) regarding the running status of print processing performed by the print device 20.

The control unit 203 controls the processing units included in the VDP application. The control unit 203 functions as a setting determination unit that refers to setting information regarding the division of a print job, which includes input information received by the input unit 201, and determines whether or not a setting for the division of the print job is made based on running status information. When the control unit 203 determines that a setting for the division of the print job has been made based on running status information, the control unit 203 refers to the record database 500 shown in FIG. 5A, and determines whether or not print data corresponding to the print job includes reusable data.

The record database 500 stores information regarding the records included in a VDP job in advance. When print data corresponding to the print job includes reusable data, the control unit 203 instructs the record collection unit 204 to collect a record of reusable data. When print data corresponding to the print job does not include reusable data, the control unit 203 analyzes a JMF Signal which has been received from the print device 20 by the JMF reception unit 202.

The record collection unit 204 functions as a collection unit that executes the following record collection processing based on the instruction given by the control unit 203. Specifically, when the record collection unit 204 is instructed by the control unit 203 to collect a record of reusable data, the record collection unit 204 collects a record of reusable data for each preset unit (e.g., for 1000 records as a unit). With this arrangement, a record group of reusable data is obtained.

When the control unit 203 determines that print data included in a VDP job does not include reusable data, the record collection unit 204 executes record collection processing in response to the analysis result of a JMF Signal. More specifically, the record collection unit 204 collects a record group of variable data based on running status information included in the JMF Signal. A print data processing unit 205 generates print data for transmission to the print device 20 for each record group collected by the record collection unit 204 in accordance with the instruction given by the control unit 203.

The data transfer unit 206 generates a print job to be executed by the print device 20 through packaging print data, which has been generated by the print data processing unit 205, in a MIME format in accordance with the instruction given by the control unit 203. With this arrangement, an original print job (VDP job) is divided. In other words, the control unit 203, the print data processing unit 205, and the data transfer unit 206 collectively function as a division unit that divides a print job for each division unit corresponding to the size of the collected variable data. Also, the data transfer unit 206 functions as a transmission unit that sequentially transmits the generated print job to the print device 20 via the external I/F 103 and the network 30.

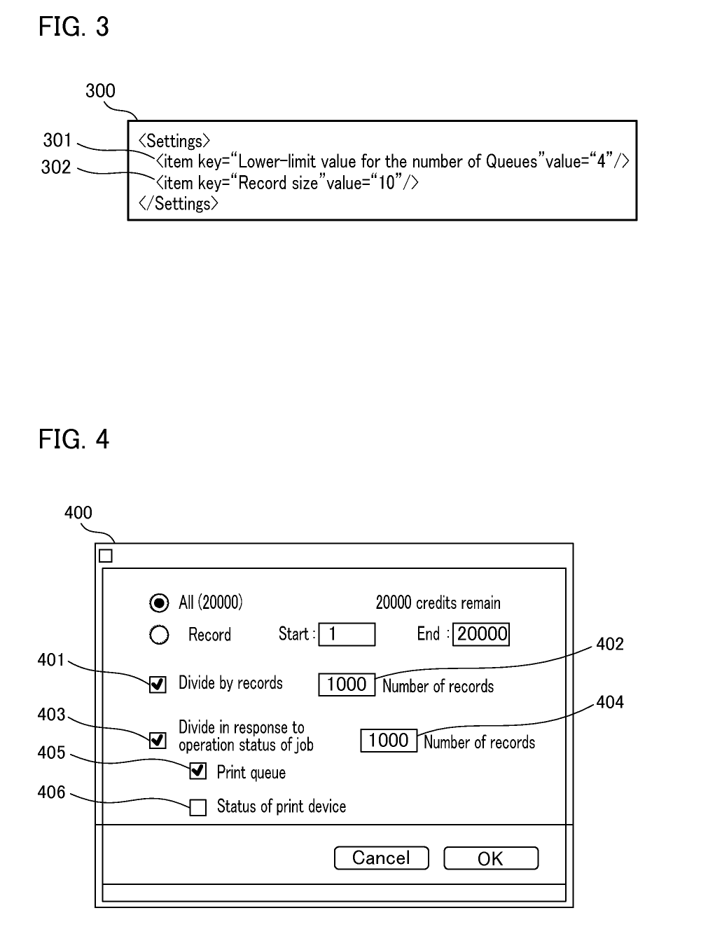

FIG. 3 is a diagram illustrating an example of a setting file of the VDP application. A setting file 300 is a file describing various setting conditions for the VDP application to be operated by the customer PC 10. In many cases, the setting file 300 is described in a plain text format and is stored in the external storage device 106 in advance.

A user of the VDP application may customize the operation of a program by changing the description content of the setting file 300 using a text editor. The setting file 300 includes key value stores 301 and 302. Each key value store includes a key attribute and a value attribute. A value corresponding to a key attribute is set to a value attribute. For example, the key attribute included in the key value store 301 indicates the lower-limit value for print queues provided in the print device 20. Then, the value attribute included in the key value store 301 indicates that the lower-limit value for a print queue is four.

A print queue is a job reception queue provided in the print device 20. The print device 20 stores a VDP job in a job reception queue, and executes a VDP job by sequentially fetching a VDP job from the head of the job reception queue. The lower-limit value for a print queue is the lower-limit value for a job stored in a job reception queue and waiting to be processed. The lower-limit value for a print queue is set in advance. If the number of VDP jobs stored in a job reception queue is below the lower-limit value for a print queue, continuous printing may be interrupted. The VDP application refers to the key value store 301 by specifying the “lower-limit value for Queue number” as the key attribute name, and thus, can acquire “4” as the lower-limit value for a print queue.

The key attribute included in the key value store 302 indicates a record size. In this example, the value attribute is set to 10 (MB) as the value of the record size. The record size preset in the key value store 302 is the reference for determining which record is to be collected by the record collection unit 204.

FIG. 4 is a diagram illustrating an example of an UI screen displayed by a VDP application. The input unit 201 included in the VDP application displays the dialogue 400 as a UI screen. The input unit 201 accepts the settings for dividing and transferring a VDP job in response to a user's operation input on the dialogue 400.

A check box 401 accepts the setting for dividing a print job for each of the number of records set on a text box 402. The text box 402 accepts information indicating the number of records by which a print job is to be divided as a unit for division. The setting regarding the division of a print job using the check box 401 and the text box 402 is referred to as the “reference division setting” in the following. When the VDP application does not divide a print job based on running status information, the VDP application divides a print job in accordance with the reference division setting. More specifically, the VDP application collects records by a unit depending on reference division setting. The text box 402 is valid only when the check box 401 is ON.

A check box 403 accepts the setting for dividing a print job based on running status information. When the check box 403 is ON and the setting for dividing a print job is made based on running status information, the VDP application collects a record of variable data in response to the setting content by a check box 405 or a check box 406. A text box 404 accepts the setting for the division unit by which the records collected in response to the setting content by the check box 405 or the check box 406 are to be divided.

Each of the check boxes 405 and 406 accepts the setting of information serving as a trigger for the division of a print job. Among information included in running status information, information serving as a trigger for the division of a print job is reference information for determining how to divide a print job by the VDP application. For example, when the check box 405 is ON, the VDP application collects a record of variable data in response to the number of jobs that are stored in a job reception queue provided in the print device 20 and waiting to be processed. The number of jobs waiting to be processed is included in a JMF Signal to be transmitted from the print device 20.

For example, when the check box 406 is ON, the VDP application collects a record of variable data in response to information indicating the status of the print device 20. Information indicating the status of the print device 20 is included in a JMF Signal to be transmitted from the print device 20. For example, information indicating the status of the print device 20 is error information indicating a paper jam, that is, a paper sheet ejection has been stopped in the print device 20. The text boxes 404 to 406 are valid only when the check box 403 is ON. Both of check box 405 and check box 406 can be used after being turned ON.

FIG. 5A and FIG. 5B are diagrams illustrating an example of record database stored in an external storage device and an example of print data corresponding to a print job. FIG. 5A is a diagram illustrating an example of a record database stored in an external storage device. The reference number “500” indicates the record database. The external storage device 106 is provided with a record database for each print job. The record database 500 shown in FIG. 5A is the record database corresponding to a print job for which the Job ID is “1”. The reference numbers “501” to “507” are the data fields of a record. Note that each of the records included in the record database 500 is a record in the variable length record format in which the size (record length) of a record configuring database is not fixed. A variable length record has a mechanism that determines the break of a record by providing a field for recording the size thereof at the head of each record.

Reference number “501” is the size of a record, reference number “502” is the customer number, reference number “503” is the name, reference number “504” is the address, reference number “505” is the link destination of the master file, reference number “506” is information about the link destination of an object 1, and reference number “507” information about the link destination of an object 2. The objects 1 and 2 are objects included in each record. Each of the objects 1 and 2 is either reusable data or variable data. The VDP application is capable of collecting a record of reusable data or variable data based on information about the link destination of each object included in the record database 500.

FIG. 5B is a diagram illustrating an example of print data included in a print job. As shown in FIG. 5B, a print job 600 for which the Job ID is “1” includes a plurality of records 601 configuring print data. Record data corresponding to the records 601 is stored in the record database 500. Each of the records 601 includes one or a plurality of pages 602. When the print job 600 is a VDP job, print data configured by a plurality of records 601 includes variable data and reusable data.

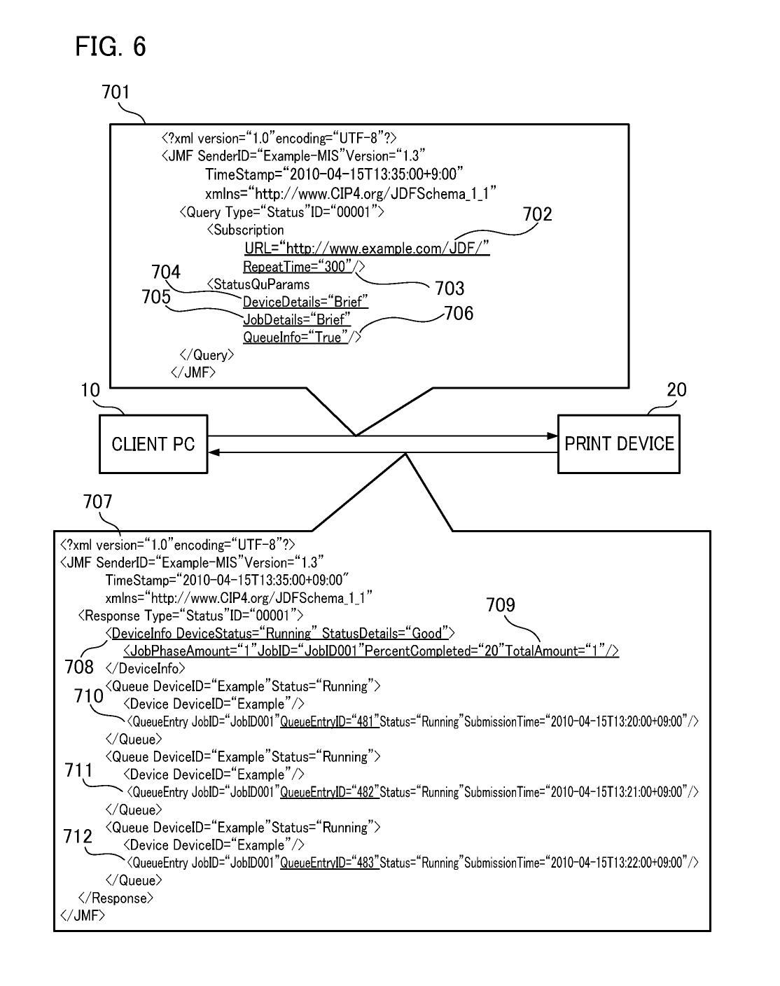

FIG. 6 is a diagram illustrating an example of a JMF Signal according to a first embodiment. The customer PC 10 periodically transmits a JMF Signal 701 to the print device 20. The JMF Signal 701 includes a request for a periodic report of information indicating the running status of a job and the status of the print device 20. An address 702 included in the JMF Signal 701 is the address of the print device 20 that is the transmission destination of the JMF Signal 701. A Repeat Time attribute 703 directs the interval of a periodic report to be made by the print device 20. In this example, the Repeat Time attribute 703 directs making a periodic report for every 300 seconds. Each of the reference numbers “704” to “706” indicates the type of information for requesting a report.

Device Details attribute 704 indicates the status of the print device 20. A Job Details attribute 705 indicates information regarding a print job. A Queue Info attribute 706 indicates the status of a print queue. The “Brief” setting, which is set for each attribute, is a setting for requesting a simple report about information corresponding to an attribute. Also, the “True” or “Full” setting, which is set to each attribute, is a setting for requesting a report of the details of information corresponding to an attribute. Further, the “None” or “False” setting, which is set to each attribute, is a setting for not requesting a report about information corresponding to an attribute.

The print device 20 that has received the JMF Signal 701 transmits a JMF Signal 707 back to the customer PC 10. The JMF reception unit 202 of the VDP application installed on the customer PC 10 receives the JMF Signal 707, and stores the JMF Signal 707 in the RAM 105.

A device status attribute 708 indicates the status of the print device 20. More specifically, the status of the print device 20 is described in Device Status attribute included in the device status attribute 708. Running, Down, Idle, or Stopped is described in Device Status attribute depending on the status of the print device 20.

Running indicates the fact that the print device 20 is processing a print job. Down indicates the state in which the print device 20 cannot process a print job due to some reason (power-supply OFF or the like). Idle indicates the state in which the print device 20 is in a print job waiting state. Stopped indicates the fact that the print device 20 is stopped due to some reason (waiting state or the like). In the present embodiment, it is assumed that the engine of the print device 20 is processing a VDP job. Thus, Running is described in the Device Status attribute.

Also, the detailed status of the print device 20 is described in Status Details attribute included in the device status attribute 708. The Status Details attribute is a detailed description of Device Status attribute. Job Held, Job Suspended, Paper Jam, or Good is set in Status Details attribute.

Job Held indicates the state in which the print device 20 holds a print job. Job Suspended indicates the state in which the print device 20 has suspended a print job in processing. Paper Jam indicates the state in which a paper jam has occurred on the print device 20. Good indicates that print is successful in processing. In this example, since no trouble occurs on the status of the print device 20, Good is set in the Status Details attribute.

A job attribute 709 indicates the status of a print job being processed by the print device 20. The ID of a print job is set in the Job ID attribute included in the job attribute 709. The number of copies in processing is set in the Amount attribute. The planned (intended to be processed) number of copies is set in the Total Amount attribute. The percentage of the progression of processing of a print job is set in the Percent Completed attribute.

The Queue Entries 710 to 712 indicate the detailed statuses of the print queues included in the print device 20. In other words, when “True” is set in the Queue Info attribute 706 included in the JMF Signal 701, a value is set in each of the Queue Entries 710 to 712.

The Job ID included in Queue Entry indicates the ID of a print job stored in a print queue. The print job stored in a print queue is a print job that is divided by the VDP application and is transmitted to the print device 20. Queue Entry ID indicates the ID of a print queue. Also, Status indicates the status of a print queue (in this example, Running status). Submission Time indicates the submission time of a print queue. Although the VDP application divides a print job and transmits the divided print jobs to the print device 20, the Job ID of each of the divided print jobs is identical. Thus, a plurality of print queues is generated for one Job ID. In this example, the number of Queue Entries indicates the number of print jobs waiting to be processed by the print device 20 (the number of jobs waiting to be printed). The number of Queue Entries changes in response to the status of print processing performed by the print device 20.

Note that the print device 20 is intended to transmit a JMF Signal for reporting the occurrence of an event to the customer PC 10 instead of transmitting a periodic report upon the occurrence of an event such as an error or the like.

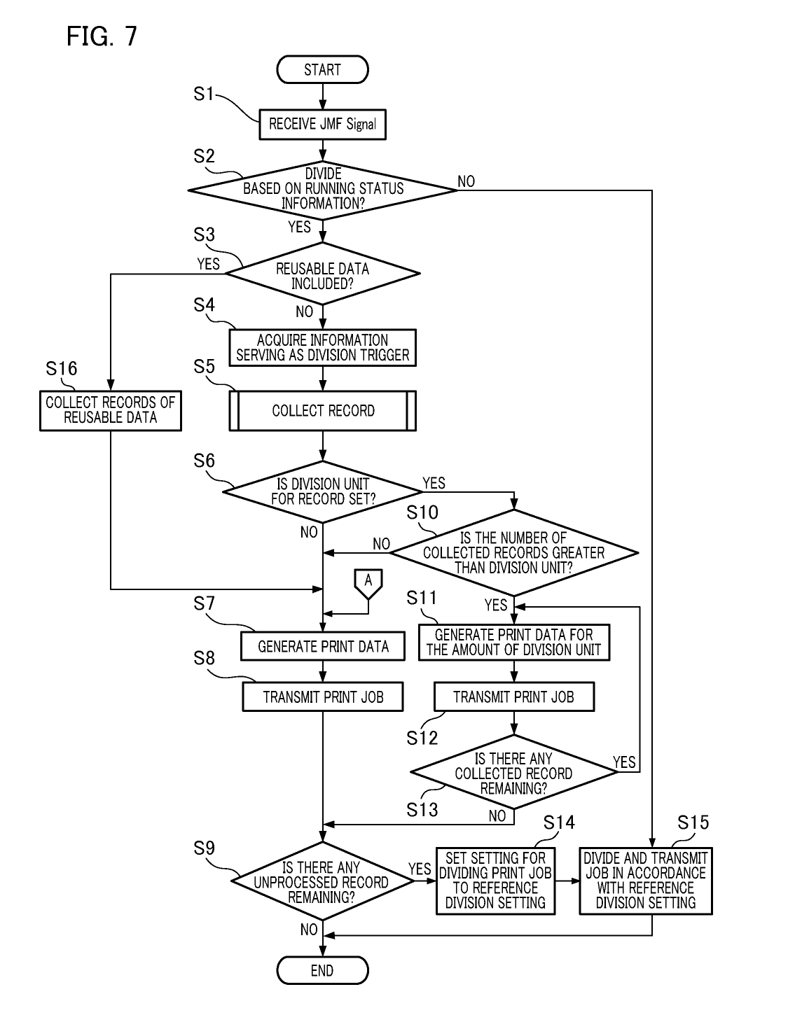

FIG. 7 is a diagram illustrating an example of the flow of division processing for a VDP job according to the first embodiment. Firstly, the JMF reception unit 202 provided in the VDP application receives the JMF Signal 707 from the print device 20, and stores the JMF Signal 707 in the RAM 105 (step S1).

Next, the control unit 203 determines whether or not the setting for dividing a VDP job has been made based on running status information (step S2). When the check box 403 on the dialogue 400 shown in FIG. 4 is ON, the control unit 203 determines that the setting for dividing a VDP job has been made based on running status information. When the check box 403 is OFF, the control unit 203 determines that the setting for dividing a VDP job has not been made based on running status information. When the control unit 203 determines that the setting for dividing a VDP job has not been made based on running status information, the process advances to step S15. Then, the VDP application divides the VDP job in accordance with the reference division setting, and transmits the divided VDP job to the print device 20 (step S15).

The process in step S15 will be specifically described. For example, when the reference division setting indicates that a print job is to be divided for each 1000 records, the record collection unit 204 refers to the record database 500, and collects the records to be processed by the print device 20 by the unit of 1000 records. The record collection unit 204 collects the records in the order that they are to be processed by the print device 20. The print data processing unit 205 generates print data for transmission to the print device 20 by the unit of 1000 records. Then, the data transfer unit 206 generates print jobs corresponding to the generated print data, and sequentially transmits the generated print jobs to the print device 20.

When the control unit 203 determines in step S2 that the setting for dividing a print job has been made based on running status information, the process advances to step S3. In step S3, the control unit 203 determines whether or not print data corresponding to the print job includes reusable data (step S3). More specifically, the control unit 203 analyzes the JMF Signal 707, shown in FIG. 6, stored in the RAM 105, and executes the following processing. The control unit 203 brings the Queue Entries 710 to 712 into association with record database stored in the external storage device 106 using, for example, the ID “Job ID 001” for the print job as the key. With this arrangement, the control unit 203 specifies the records corresponding to the print job, and confirms that how many records among the records included in the print job have already been transmitted to the print device 20. In this example, the records corresponding to the print job are intended to be included in the record database 500 shown in FIG. 5A. Upon association, the control unit 203 determines whether or not reusable data is included in the record database 500. When reusable data is included in the record database 500, the control unit 203 determines that print data corresponding to the print job includes reusable data. When print data corresponding to the print job does not include reusable data, the process advances to step S4.

When print data corresponding to the print job includes reusable data, the record collection unit 204 refers to the record database 500, and collects a record of reusable data (step S16). Then, the process advances to step S7. In step S16, the record collection unit 204 collects a record of reusable data in units corresponding to the reference division setting.

In step S4, the control unit 203 acquires information serving as a trigger for the division of a print job from the JMF Signal 707 (step S4). In the present embodiment, the check box 405 on the dialogue 400 shown in FIG. 4 is ON, and information serving as a trigger for the division of a print job is the number of jobs stored in a job reception queue provided in the print device 20 and waiting to be processed. Thus, the control unit 203 refers to the JMF Signal 707, and acquires the number of Queue Entries as the number of jobs waiting to be processed.

Next, the record collection unit 204 collects records based on information serving as a trigger for the division of a print job, which has been acquired in step S4 (step S5). The records collected in step S5 are records of variable data.

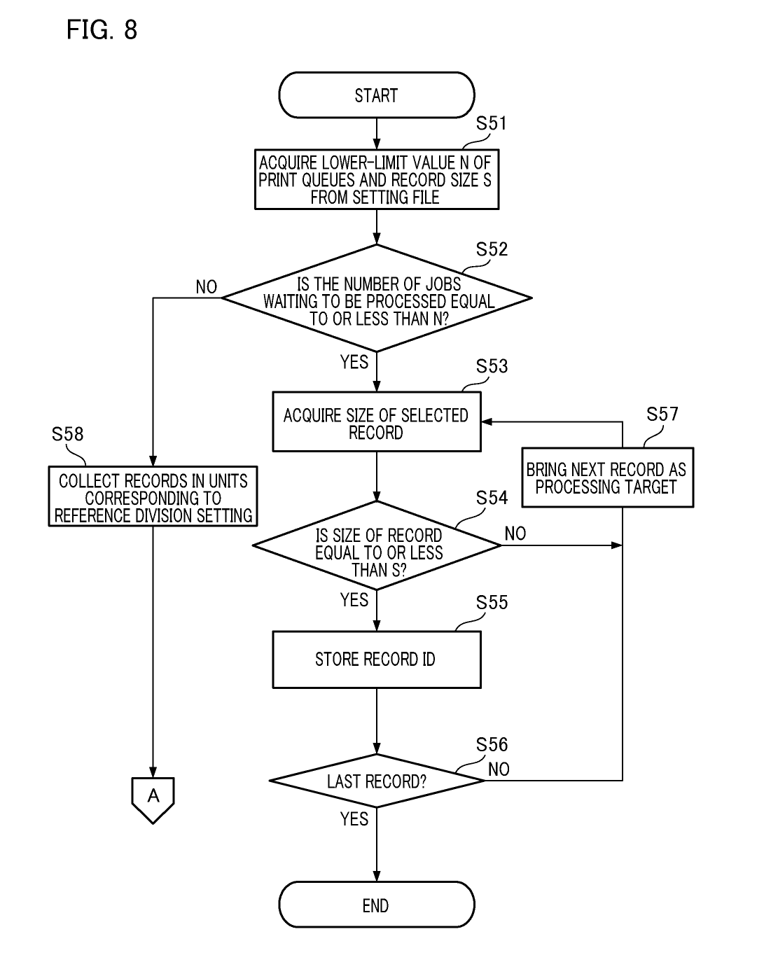

FIG. 8 is a flowchart illustrating an example of record collection processing in step S5. Firstly, the record collection unit 204 refers to the setting file 300 shown in FIG. 3, and acquires the lower-limit value N of print queues and the record size S (step S51). Next, the record collection unit 204 determines whether or not the number of jobs waiting to be processed, which has been acquired in step S4 shown in FIG. 7, is equal to or less than the lower-limit value N of the print queue (step S52). When the number of jobs waiting to be processed is greater than the lower-limit value N of the print queue, the record collection unit 204 collects records in units corresponding to the reference division setting (step S58), and the process advances to step S7 shown in FIG. 7.

When the number of jobs waiting to be processed is equal to or less than the lower-limit value N of the print queue, the record collection unit 204 refers to the record database 500, and selects one of the records to thereby acquire the record size of the selected record (step S53). Among the unprocessed records, the record collection unit 204 selects the records in the ascending order of customer number.

Next, the record collection unit 204 determines whether or not the size of the record selected in step S53 is equal to or less than the record size S acquired in step S51 (step S54). When the size of the record selected in step S53 is greater than the record size S, the record collection unit 204 brings the next record as the processing target (step S57), and the process returns to step S53.

When the size of the record selected in step S53 is equal to or less than the record size S, the record collection unit 204 collects the record, and stores the ID (record ID) for identifying the record in the RAM 105 (step S55).

Next, the record collection unit 204 determines whether or not the last record included in the record database 500 has been processed (step S56). When the record collection unit 204 determines that the last record included in the record database 500 has been processed, the process is ended. When the record collection unit 204 determines that the last record included in the record database 500 has not yet been processed, the process advances to step S57. In other words, when the record collection unit 204 determines that the number of jobs waiting to be printed is equal to or less than a predetermined threshold value and the number of jobs waiting to be printed is equal to or less than the threshold value (Yes in step S52), the record collection unit 204 collects a record of variable data for which the size is equal to or less than a predetermined threshold value (step S55).

Referring back to FIG. 7, the control unit 203 determines whether or not a unit for division of the records collected in step S5 has been set (step S6). More specifically, the control unit 203 determines whether or not a value has been set in the text box 404 in the dialogue 400 shown in FIG. 4. The value set in the text box 404 indicates a unit for division of the records collected in step S5. Thus, when a value has been set in the text box 404, the control unit 203 determines that a unit for division of the records collected in step S5 has been set. When no value has been set in the text box 404, the control unit 203 determines that a unit for division of the records collected in step S5 has not been set.

When the control unit 203 determines that a unit for division of the records collected in step S5 has not been set, the process advances to step S7. When the control unit 203 determines that a unit for division of the records collected in step S5 has been set, the control unit 203 determines whether or not the number of records collected in step S5 is greater than a unit for division of the records (step S10). When the control unit 203 determines that the number of records collected in step S5 is not greater than a unit for division of the records, the process advances to step S7.

When the control unit 203 determines that the number of records collected in step S5 is greater than a unit for division of the records, the print data processing unit 205 generates print data for the amount of a unit for division of the records (step S11). More specifically, the print data processing unit 205 sequentially acquires the records corresponding to the record IDs from the record collection unit 204, which have been stored in the RAM 105 in step S55 shown in FIG. 8, in accordance with the instruction given by the control unit 203, and thus, generates print data for the amount of a unit for division of the records.

Then, the data transfer unit 206 generates print jobs corresponding to the generated print data in accordance with the instruction given by the control unit 203, and sequentially transmits the generated print jobs to the print device 20 (step S12). In other words, when the number of the collected records of variable data exceeds the predetermined number of records, the control unit 203 divides a print job while holding the predetermined number of records as a unit for division.

Next, the print data processing unit 205 determines whether or not there is any collected record remaining (step S13). When the print data processing unit 205 determines that there is a collected record(s) remaining, the process advances to step S11. When the print data processing unit 205 determines that there is no collected record remaining, the process advances to step S9.

In step S7, the print data processing unit 205 generates print data for transmission to the print device 20 based on the collected records (step S7). For example, when the answer in determination processing in steps S6 and S10 is “No”, the print data processing unit 205 generates print data for the record group (a record group of variable data) collected in step S5 as print data for transmission to the print device 20. For example, the print data processing unit 205 generates print data for the record group (a record group of reusable data) collected in step S16 as print data for transmission to the print device 20. Next, the data transfer unit 206 generates a print job including print data generated in step S7, and transmits the print job to the print device 20 (step S8). In step S8, the data transfer unit 206 transmits a print job corresponding to reusable data to the print device 20 prior to a print job corresponding to variable data.

Next, the control unit 203 determines whether or not there is any unprocessed record remaining in the record database 500 (step S9). When the control unit 203 determines that there is no unprocessed record remaining in the record database 500, the process is ended. When the control unit 203 determines that there is any unprocessed record remaining in the record database 500, the process advances to step S14. Then, the control unit 203 sets the setting for dividing a print job to the reference division setting (step S14), and the process advances to step S15.

According to the print control device of the first embodiment, a record, which has a small size and does not take time to transfer, may be transmitted to the print device 20, when the number of jobs waiting to be processed in a job reception queue provided in the print device 20 is small and continuous printing is about to be interrupted. Thus, according to the print control device of the first embodiment, continuous printing is not interrupted, and thus, a VDP job may be processed in a quick manner.

Next, a description will be given of a second embodiment. In the second embodiment, the check box 406 is set to “ON” in the dialogue 400 shown in FIG. 4, and the VDP application divides a print job in response to information indicating the status of the print device 20. In the present embodiment, information serving as a trigger for the division of a print job is intended to be error information indicating the fact that a paper jam has occurred on the print device 20. Thus, the VDP application divides a print job based on error information, which is included in a JMF Signal transmitted from the print device 20, indicating the fact that a paper jam has occurred on the print device 20.

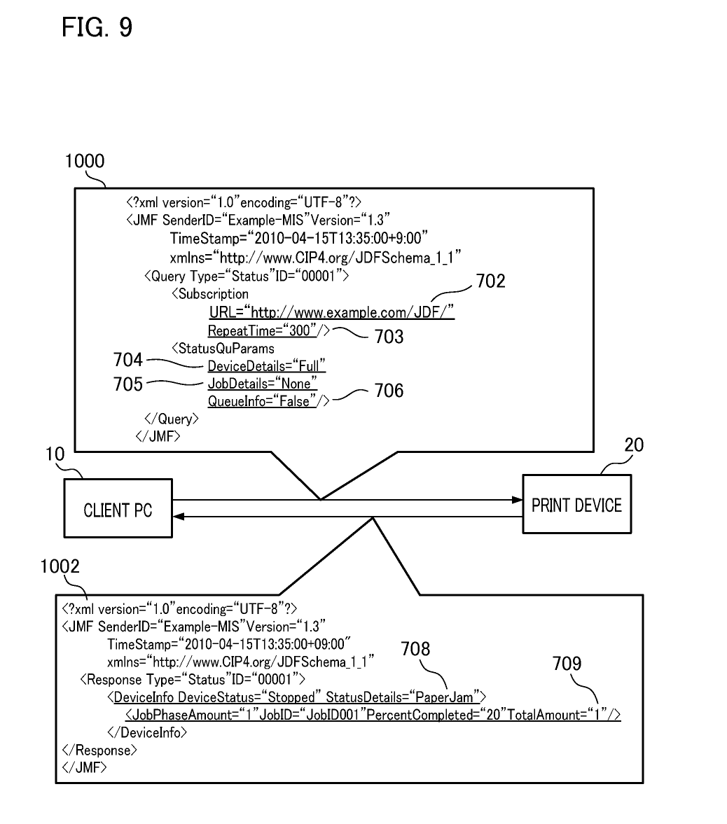

FIG. 9 is a diagram illustrating an example of a JMF Signal according to a second embodiment. A JMF Signal 1000 is a JMF Signal that is transmitted from the customer PC 10 to the print device 20. A JMF Signal 1002 is a JMF Signal that is transmitted from the print device 20 to the customer PC 10.

As in the JMF Signal 701 shown in FIG. 6, the JMF Signal 1000 includes the address 702, the Repeat Time attribute 703, the Device Details attribute 704, the Job Details attribute 705, and the Queue Info attribute 706. In this example, since “Full” is set in the Device Details attribute 704, the customer PC 10 makes a request for the report of the details of the status of the print device 20 with respect to the print device 20.

As in the JMF Signal 707 shown in FIG. 6, the JMF Signal 1002 includes the device status attribute 708 and the job attribute 709. In this example, “Stopped” is set in the Device Status attribute. Also, “Paper Jam” is set in the Status Details attribute included in the device status attribute 708. Thus, the print device 20 is in the error state in which a paper jam has occurred.

VDP job division processing according to the second embodiment is the same as VDP job division processing according to the first embodiment described with reference to FIG. 7 except for the processes in steps S4 and S5 shown in FIG. 7.

In step S4 shown in FIG. 7, the VDP application of the second embodiment acquires error information indicating a Paper Jam, that is, the fact that a paper jam has occurred on the print device 20 as information serving as a trigger for the division of a print job from the JMF Signal 1002. Then, in step S5 shown in FIG. 7, the VDP application collects records based on error information indicating the fact that a paper jam has occurred on the print device 20.

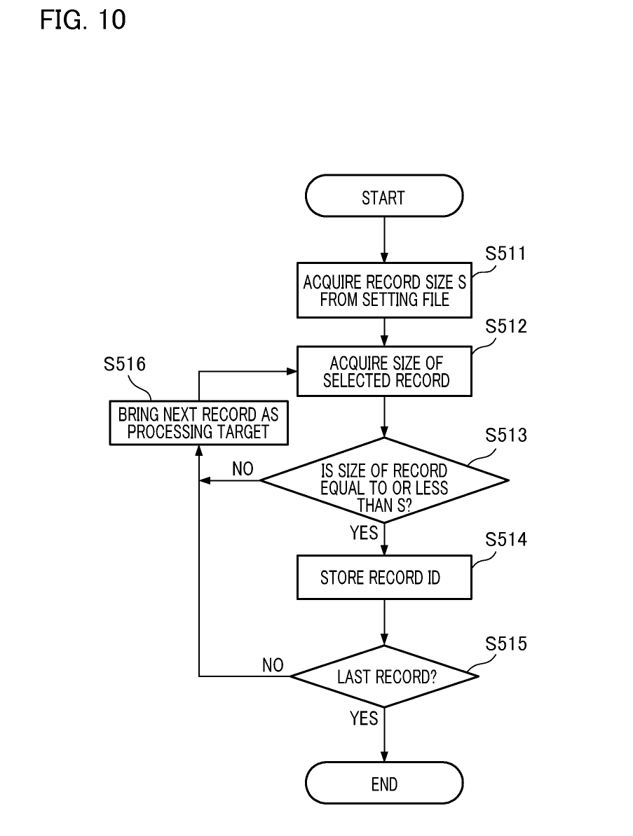

FIG. 10 is a flowchart illustrating an example of record collection processing according to the second embodiment. Firstly, the record collection unit 204 refers to the setting file 300, and acquires the record size S (step S511). Next, the record collection unit 204 refers to the record database 500, and selects one of the records to thereby acquire the record size of the selected record (step S512). Among the unprocessed records, the record collection unit 204 selects the records in the ascending order of the customer number.

Next, the record collection unit 204 determines whether or not the size of the record selected in step S512 is equal to or greater than the record size S acquired in step S511 (step S513). When the size of the record selected in step S512 is smaller than the record size S, the record collection unit 204 sets the next record as the processing target (step S516), and the process returns to step S512.

When the size of the record selected in step S512 is equal to or greater than the record size S, the record collection unit 204 collects the record, and stores the ID (record ID) for identifying the record in the RAM 105 (step S514).

Next, the record collection unit 204 determines whether or not the last record included in the record database 500 has been processed (step S515). When the record collection unit 204 determines that the last record included in the record database 500 has been processed, the process is ended. When the record collection unit 204 determines that the last record included in the record database 500 has not yet been processed, the process advances to step S516. In other words, when the running status information includes error information indicating that a paper sheet ejection has been stopped in the print device 20, the record collection unit 204 collects a record of variable data of which the size is equal to or greater than a predetermined threshold value.

A print job including the records collected by the processing described with reference to FIG. 10 is transmitted to the print device 20 through the processing in steps S7 and S8 shown in FIG. 7. When the engine of the print device 20 is stopped and a paper jam has occurred, the print control device of the second embodiment transmits a record, which has a large size and takes time to transfer, to the print device 20. Thus, the number of jobs waiting to be printed in a job reception queue provided in the print device 20 may be prevented from being lost. Consequently, continuous printing is not interrupted, and thus, a VDP job may be processed in a quick manner.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-286987 filed Dec. 24, 2010, which is hereby incorporated by reference herein in its entirety.

What is claimed is:

1. A print control device that divides a print job, transmits the divided print job to an image forming device, and causes the image forming device to execute print processing for print data corresponding to the print job,
wherein the print data is first data that is shared among a plurality of pages or second data that is variable for each page,
the print control device comprising:
a reception unit configured to receive running status information regarding the running status of the print processing from the image forming device;
a setting determination unit configured to refer to setting information regarding the division of the print job and to determine whether or not a setting for the division of the print job is made based on the running status information;
a collection unit configured to collect a record of the second data based on the running status information when the setting determination unit has determined that a setting for the division of the print job is made based on the running status information;
a division unit configured to divide the print job for each division unit corresponding to the number of records of the collected second data; and
a transmission unit configured to transmit the divided print job to the image forming device.

2. The print control device according to claim 1, wherein the running status information includes the number of jobs waiting to be printed, which is the number of print jobs in a waiting to be processed state in the image forming device, and
wherein the collection unit determines whether or not the number of jobs waiting to be printed is equal to or less than a predetermined threshold value, and collects a record of second data, of which the size is equal to or less than a predetermined threshold value, when the number of jobs waiting to be printed is equal to or less than the threshold value.

3. The print control device according to claim 1, wherein the collection unit collects a record of second data, of which the size is equal to or less than a predetermined threshold value, when the running status information includes error information indicating that paper sheet ejection has been stopped in the image forming device.

4. The print control device according to claim 2, wherein the division unit further divides the print job for each division unit corresponding to the predetermined number of records when the number of records of the collected second data exceeds the predetermined number of records.

5. A print control method that divides a print job, transmits the divided print job to an image forming device, and causes the image forming device to execute print processing for print data corresponding to the print job,
wherein the print data is first data that is shared among a plurality of pages or second data that is variable for each page,
the print control method comprising:
receiving running status information regarding the running status of the print processing from the image forming device;
determining whether or not a setting for the division of the print job is made based on the running status information by referring to setting information regarding the division of the print job;
collecting a record of the second data based on the running status information when it has been determined that a setting for the division of the print job is made based on the running status information;
dividing the print job for each division unit corresponding to the number of records of the collected second data; and
transmitting the divided print job to the image forming device.

6. A storage medium storing a computer-readable program for causing a computer to execute a print control method that divides a print job, transmits the divided print job to an image forming device, and causes the image forming device to execute print processing for print data corresponding to the print job,
wherein the print data is first data that is shared among a plurality of pages or second data that is variable for each page,
the print control method comprising:
receiving running status information regarding the running status of the print processing from the image forming device;
determining whether or not a setting for the division of the print job is made based on the running status information by referring to setting information regarding the division of the print job;
collecting a record of the second data based on the running status information when it has been determined that a setting for the division of the print job is made based on the running status information;
dividing the print job for each division unit corresponding to the number of records of the collected second data; and
transmitting the divided print job to the image forming device.
